(19) United States
(12) Patent Application Publication
(10) Pub. No.: US 2019/0063486 A1
(43) Pub. Date: Feb. 28, 2019

(54) DOUBLE NUT HAVING ANTI-LOOSENING PART

(71) Applicant: Core Bolt Co., LTD., Gwamgju (KR)

(72) Inventor: Young Kwon Kim, Haenam (KR)

(73) Assignee: Core Bolt Co., LTD., Gwangju (KR)

(21) Appl. No.: 15/987,946

(22) Filed: May 24, 2018

(30) Foreign Application Priority Data
Aug. 31, 2017 (KR) 10-2017-0111245

(51) Int. Cl. F16B 39/24

(52) U.S. Cl. CPC F16B 39/24

(57) ABSTRACT

The present invention relates to a double nut including: a double nut part having a lower nut fastened to a lower peripheral surface of a protruding region of a bolt inserted protrudingly into fastening holes formed on fastening objects to be fastened together and an upper nut fastened to an upper peripheral surface of the protruding region of the bolt; and an anti-loosening part disposed between the lower nut and the upper nut to apply elasticity to the lower nut and the upper nut in a direction where the lower nut and the upper nut are distant from each other, wherein the lower nut and the upper nut have locking grooves concavely formed on top and underside thereof, so that one end and the other end of the elastic coil spring are locked onto the locking grooves.

### CROSS REFERENCE TO RELATED APPLICATION OF THE INVENTION

The present application claims the benefit of Korean Patent Application No. 10-2017-0111245 filed in the Korean Intellectual Property Office on Aug. 31, 2017, the entire contents of which are incorporated herein by reference.

### BACKGROUND OF THE INVENTION

### Field of the Invention

The present invention relates to a double nut adapted to prevent nuts and a bolt tightened from being loosened, and more particularly, to a double nut that has an anti-loosening part disposed between two facing nuts so that even if vibrations are continuously applied to the nuts, the nuts can be firmly kept tightened.

### Background of the Related Art

A bolt and a nut are used to firmly fasten two or more members together in a structure such as a machine, pier, tower, ship, automobile, aircraft, and so on.

Like this, the bolt and the nut are screw-fastened to each other to couple the two or more members to each other, and in this state, if vibrations or impacts are continuously applied to the fastened portion of the bolt and the nut from the outside, the bolt and the nut are slowly loosened in the opposite direction to their fastened direction.

In case of bolts and nuts used in rails along which a train runs, for example, they are loosened due to vibrations and impacts generated while the train is running.

As the fastened states between the bolts and the nuts are loosened, further, gaps on the rails may be generated, which unfortunately causes big accidents.

In addition, such loosening may be generated in various industrial sites or devices, which undesirably causes serious safety accidents.

In the industrial sites wherein strong impacts or vibrations are continuously applied to the fastened portion between the bolt and the nut, especially, there is a definite need to solve safety problems caused by the loosening of the bolt and the nut.

### SUMMARY OF THE INVENTION

Accordingly, the present invention has been made in view of the above-mentioned problems occurring in the prior art, and it is an object of the present invention to provide a double nut that is capable of allowing nuts and a bolt to be kept tightened, without being loosened, even if strong vibrations or impacts are continuously applied thereto.

It is another object of the present invention to provide a double nut that is capable of easily preventing nuts and a bolt from being loosened through a simple structure, without having any complicate mechanical structure or any separate member.

It is yet another object of the present invention to provide a double nut that is capable of additionally machining existing bolts to provide easy machinability in manufacturing and that is also applicable to large-sized specific bolts to provide the use in various industrial fields.

To accomplish the above-mentioned objects, according to the present invention, there is provided a double nut including: a double nut part having a lower nut fastened to a lower peripheral surface of a protruding region of a bolt inserted protrudingly into fastening holes formed on fastening objects to be fastened together and an upper nut fastened to an upper peripheral surface of the protruding region of the bolt; and an anti-loosening part disposed between the lower nut and the upper nut to apply elasticity to the lower nut and the upper nut, so that the lower nut and the upper nut are distant from each other and fixed in position thereto, and after that, the upper nut rotates in an opposite direction to a direction of a screw thread of the bolt, while not exceeding one pitch of the bolt, and is thus locked thereonto to restrain the fastened state to the protruding region of the bolt.

According to the present invention, desirably, the anti-loosening part is formed of an elastic coil spring fitted to an outer peripheral surface of the bolt in such a manner as to be compressedly disposed between the lower nut and the upper nut, the elastic coil spring having one end coming into contact with the top of the lower nut to restrain the lower nut thereonto and the other end coming into contact with the underside of the upper nut to restrain the upper nut thereonto.

According to the present invention, desirably, the elastic coil spring have tip portions gradually narrow in width toward one end and the other end thereof, and the lower nut and the upper nut have locking grooves concavely formed on top and underside thereof, so that one end and the other end of the elastic coil spring are locked onto the locking grooves.

According to the present invention, desirably, the lower nut and the upper nut have spiral guide grooves formed concavely on the top and underside fastened to one end and the other end of the elastic coil spring along a circumferential direction of the elastic coil spring, and each locking groove of the lower nut and the upper nut is formed on a boundary region on which both ends of the corresponding guide groove come into contact with each other.

According to the present invention, desirably, one end of each guide groove is connected to the bottom of the corresponding locking groove, and the other end thereof is connected to the top of the corresponding locking groove.

According to the present invention, desirably, an advancing direction of the screw thread formed on the outer peripheral surface of the bolt is opposite to a rotating direction of the elastic coil spring, and the locking grooves have shapes of planes perpendicular to the top of the lower nut and the underside of the upper nut, more desirably, the locking grooves being concavely formed in an advancing direction of the elastic coil spring.

According to the present invention, desirably, a pitch of the screw thread formed on the outer peripheral surface of the bolt is shorter than a pitch of a coil constituting the elastic coil spring.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a perspective view showing an underside structure of an upper nut in a double nut having an anti-loosening part according to the present invention;

FIG. 2 is a perspective view showing a top structure of a lower nut in the double nut having an anti-loosening part according to the present invention;

FIG. 3 is an exploded perspective view showing the double nut having an anti-loosening part according to the present invention;

FIG. 4 is a longitudinal sectional view showing an assembled structure of the double nut having an anti-loosening part according to the present invention;

FIG. 5 is a side view showing a tightened structure of the double nut according to the present invention to a plate-shaped structure;

FIG. 6 is a perspective view showing a tightened structure of the double nut according to the present invention to a bottom surface of a support pillar; and

FIG. 7 is a perspective view showing an operation of disassembling the double nut according to the present invention by means of an impact driver.

### DETAILED DESCRIPTION OF THE PREFERRED EMBODIMENTS

Hereinafter, the present invention is disclosed with reference to the attached drawings wherein the corresponding parts in the embodiments of the present invention are indicated by corresponding reference numerals.

In the description or claims, when it is said that one portion is described as “includes” any component, one element further may include other components unless no specific description is suggested.

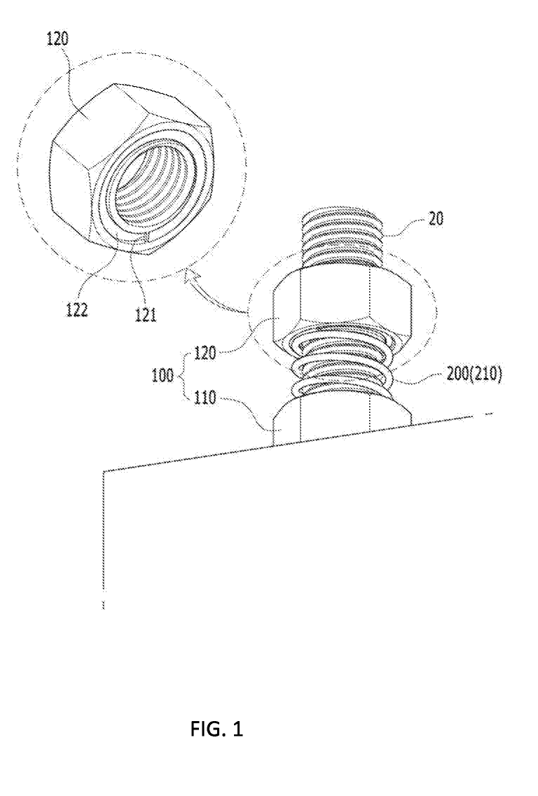

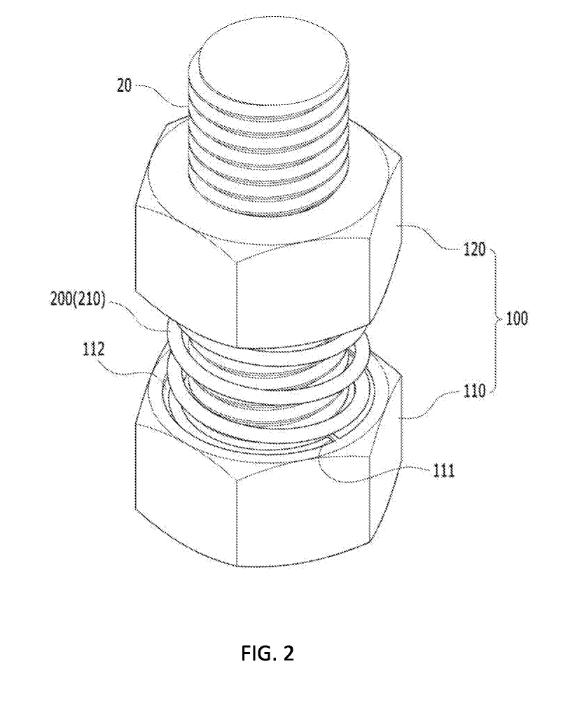

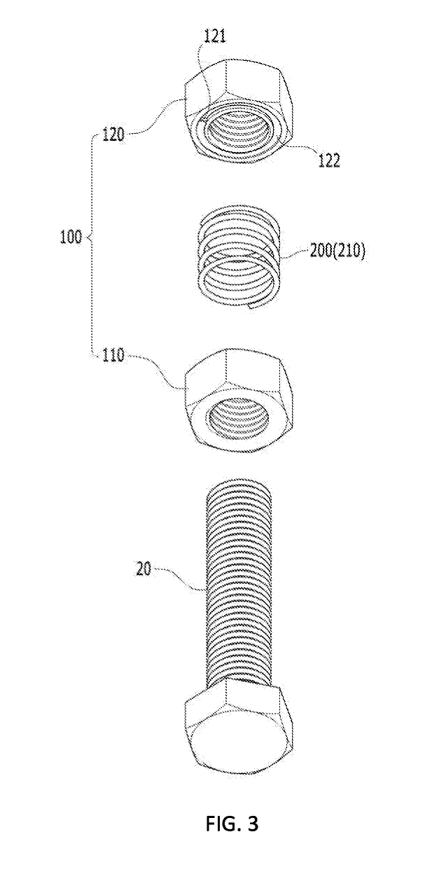

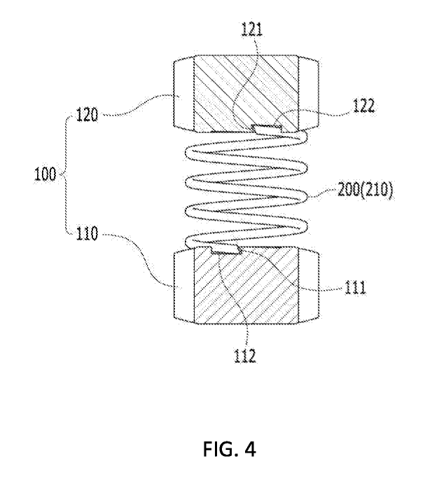

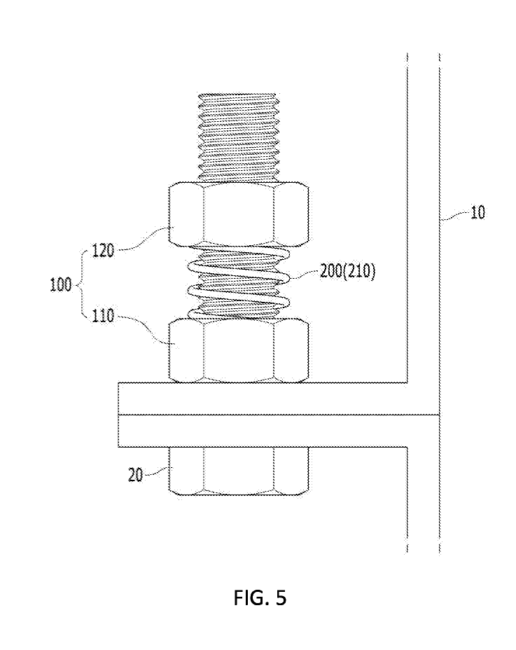

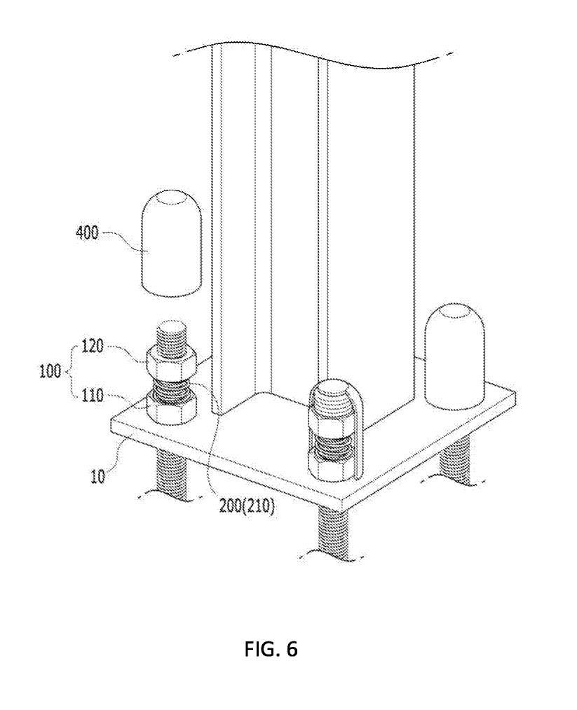

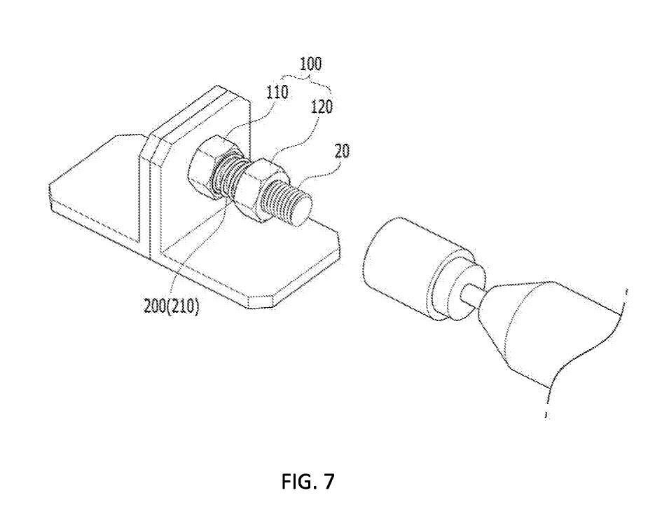

FIG. 1 is a perspective view showing an underside structure of an upper nut in a double nut having an anti-loosening part according to the present invention, FIG. 2 is a perspective view showing a top structure of a lower nut in the double nut having an anti-loosening part according to the present invention, FIG. 3 is an exploded perspective view showing the double nut having an anti-loosening part according to the present invention, FIG. 4 is a longitudinal sectional view showing an assembled structure of the double nut having an anti-loosening part according to the present invention, FIG. 5 is a side view showing a tightened structure of the double nut according to the present invention to plate-shaped structures, FIG. 6 is a perspective view showing a tightened structure of the double nut according to the present invention to a bottom surface of a support pillar, and FIG. 7 is a perspective view showing an operation of disassembling the double nut according to the present invention by means of an impact driver.

Now, an explanation on a double nut according to the present invention will be in detail given with reference to the attached drawing.

As shown, a double nut according to the present invention includes: a double nut part 100 having a lower nut 110 fastened to a lower peripheral surface of a protruding region of a bolt inserted protrudingly into fastening holes formed on fastening objects 10 to be fastened together and an upper nut 120 fastened to an upper peripheral surface of the protruding region of the bolt 20; and an anti-loosening part 200 disposed between the lower nut 110 and the upper nut 120 to apply elasticity to the lower nut 110 and the upper nut 120 in a direction where the lower nut 110 and the upper nut 120 are distant from each other and thus to restrain the fastened states of the lower nut 110 and the upper nut 120 to the protruding region of the bolt 20.

The bolt 20 includes a bar-shaped body having a screw thread formed along the outer peripheral surface thereof and a head having a larger diameter than the body, so that the head is locked onto the fastening holes of the fastening objects and the body passes through the fastening holes in such a manner as to protrude outward from the fastening holes by a given length.

The lower nut 110 is fastened to the lower peripheral surface of the body of the bolt 20 protruding outward from the fastening holes and thus pressurizes external surfaces of the fastening objects 10 to allow the fastening objects 10 to be kept fastened. The lower nut 110 has a polygonal-shaped outer peripheral surface so that it rotates by means of a tool like a monkey spanner or wrench and is thus fastened firmly to the body of the bolt 20.

The lower nut 110 has a locking groove 111 formed on top thereof in such a manner as to allow one end of an elastic coil spring 210 fitted to the outer peripheral surface of the bolt 20 to be locked thereonto to restrain free rotation of the elastic coil spring 210.

Further, the lower nut 110 has a spiral guide groove 112 formed concavely on the top thereof in a circumferential direction of the elastic coil spring 210, so that upon an initial contact so as to allow one end of the elastic coil spring 210 to be locked onto the locking groove 111, one end of the elastic coil spring 210 desirably rotates along the guide groove 112 in a state of coming into contact with the top of the lower nut 110.

At this time, the locking groove 111 is formed on a boundary region on which both ends of the guide groove 112 come into contact with each other. One end of the guide groove 112 is connected to a bottom end of the locking groove 111, and the other end of the guide groove 112 to a top end of the locking groove 111.

In detail, the guide groove 112 becomes spirally concave from the top of the lower nut 110 in such a manner as to be connected to the bottom end of the locking groove 111.

The locking groove 111 of the lower nut 110 has a shape of a plane perpendicular to the top of the lower nut 110, but more desirably, the locking groove 111 becomes concave in the advancing direction of the elastic coil spring 210.

The upper nut 120 is fastened to the body of the outwardly protruding bolt 20 at a position where it is spaced apart from the lower nut 110 by a given distance above the lower nut 110. In the same manner as the lower nut 110, the upper nut 120 has a polygonal-shaped outer peripheral surface so that it rotates by means of a tool like a monkey spanner or wrench.

The upper nut 120 has a locking groove 121 formed on underside thereof in such a manner as to allow the other end of the elastic coil spring 210 to be locked thereonto to restrain the free rotation of the elastic coil spring 210 fitted to the outer peripheral surface of the bolt 20.

Further, the upper nut 120 has a spiral guide groove 122 formed concavely on the underside thereof in the circumferential direction of the elastic coil spring 210, so that upon an initial contact so as to allow the other end of the elastic coil spring 210 to be locked onto the locking groove 121, the other end of the elastic coil spring 210 desirably rotates along the guide groove 122 in a state of coming into contact with the underside of the upper nut 120.

At this time, the locking groove 121 is formed on a boundary region on which both ends of the guide groove 122 come into contact with each other. One end of the guide groove 122 is connected to a bottom end of the locking groove 121, and the other end of the guide groove 122 to a top end of the locking groove 121.

In detail, the guide groove 122 becomes spirally concave from the underside of the upper nut 120 in such a manner as to be connected to the top end of the locking groove 121.

The locking groove 121 of the upper nut 120 has a shape of a plane perpendicular to the top of the upper nut 120, but more desirably, the locking groove 121 becomes concave in the advancing direction of the elastic coil spring 210.

On the other hand, the anti-loosening part 200 is fitted to the outer peripheral surface of the bolt 20 between the lower nut 110 and the upper nut 120. The anti-loosening part 200 is formed of the elastic coil spring 210 having one end coming into contact with the top of the lower nut 110 and the other end coming into contact with the underside of the upper nut 120, so that it is compressed between the lower nut 110 and the upper nut 120.

One end and the other end of the elastic coil spring 210 are locked onto the locking groove 111 formed on the top of the lower nut 110 and the locking groove 121 formed on the underside of the upper nut 120, so that the free rotation of the elastic coil spring 210 can be restrained.

Desirably, the elastic coil spring 210 have tip portions becoming narrow in width toward one end and the other end thereof so that the outer peripheral surfaces of one end and the other end thereof are inclinedly formed. For example, one end and the other end of the elastic coil spring 210 are cut up and down obliquely so that the cut surfaces meet each other on a straight line.

In this case, desirably, the locking groove 111 formed on the top of the lower nut 110 and the locking groove 121 formed on the underside of the upper nut 120 are concave laterally in correspondence with the shapes of one end and the other end of the elastic coil spring 210.

Desirably, the advancing direction of the screw thread formed on the outer peripheral surface of the bolt 20 is opposite to the rotating direction of the elastic coil spring 210, and the locking groove 111 of the lower nut 110 faces the locking groove 121 of the upper nut 120.

Accordingly, when the upper nut 120 rotates to compress the elastic coil spring 210 thereagainst, the other end of the elastic coil spring 210 is not locked onto the locking groove 121 of the upper nut 120, but it slides along the guide groove 122 formed on the underside of the upper nut 120. In this case, the other end of the elastic coil spring 210 is kept at a given position by means of the guide groove 122, without being freely moved.

As the upper nut 120 rotates, accordingly, it can be spaced apart from the lower nut 110 by a sufficiently close distance to the lower nut 110.

If the upper nut 120 rotates oppositely, however, the other end of the elastic coil spring 210 is locked onto the locking groove 121 of the upper nut 120 in the state where one end of the elastic coil spring 210 is locked on the locking groove 111 of the lower nut 110, so that a state as shown in FIG. 4 is provided.

As shown in FIG. 4, the elastic coil spring 210 is kept constant in thickness over most of the region thereof, but it becomes tapered on both ends thereof. Such shape of the elastic coil spring 210 is obtained by slantly cutting both ends of the existing spring to a given angle, so that contact areas of the elastic coil spring 210 with the upper nut 120 and the lower nut 110 can be enlarged.

On the other hand, as shown in FIG. 4, the locking groove 111 is concavely bent inward from the lower nut 110 to have a shape of ‘>’. As a result, the end of the elastic coil spring 210 insertedly slides along the inner surface of the locking groove 111 and is thus locked easily onto the locking groove 111.

In the state as shown in FIG. 4, on the other hand, the upper nut 120 is kept by means of the elasticity of the elastic coil spring 210, without being loosened anymore. In a state where the elastic coil spring 210 is not sufficiently compressed, however, it is possible to rotate the upper nut 120 in a direction of compressing the elastic coil spring 210, so that desirably, the isolation distance between the upper nut 120 and the lower nut 110 has to become closer.

Desirably, a spiral direction of a coil constituting the elastic coil spring 210 is opposite to a direction of the screw thread formed on the outer peripheral surface of the bolt 20, and when the upper nut 120 rotates to compress the elastic coil spring 210 thereagainst, accordingly, the end portion of the elastic coil spring 210 naturally slides over the locking groove 121 of the upper nut 120, so that it is possible to gently compress the elastic coil spring 210. If the upper nut 120 rotates to be unfastened from the bolt 20, the end portion of the elastic coil spring 210 is locked onto the locking groove 121, thereby preventing the rotation of the elastic coil spring 210.

Further, a pitch of the screw thread formed on the outer peripheral surface of the bolt 20 is desirably shorter than a pitch of the coil constituting the elastic coil spring 210.

In the state where the elastic coil spring 210 is compressedly fitted to the outer peripheral surface of the bolt between the lower nut 110 and the upper nut 120, if an external force in a direction of loosening the upper nut 120 from the bolt 20 is applied to cause the upper nut 120 to rotate by a given angle, the locked state of the other end of the elastic coil spring 210 onto the locking groove 121 is not released only through the rotation by the given angle because of the shorter pitch of the screw thread formed on the outer peripheral surface of the bolt 20 than the pitch of the coil constituting the elastic coil spring 210, thereby preventing the upper nut 120 from being loosened.

As shown in FIG. 6, after an object to be fastened is fastened to a structure by means of the bolt 20, the lower nut 110, the upper nut 120, and the elastic coil spring 210, a cap member 300 is fastened to the outer peripheries of the protruding region of the bolt 20, the lower nut 110, the upper nut 120, and the elastic coil spring 210 so as to block them from the outside.

Under the above-mentioned configuration, the double nut having the anti-loosening part 200 according to the present invention does not adopt elastic pressurization of the elastic coil spring 210, but locates the elastic coil spring 210 in the opposite direction to the direction of the screw thread formed on the outer peripheral surface of the bolt 20, so that one end and the other end of the elastic coil spring 210 are locked onto the locking groove 111 formed on the top of the lower nut 110 and the locking groove 121 formed on the underside of the upper nut 120, and if the upper nut 120 seems to be loosened, an elastic repulsion force is applied from the elastic coil spring 210 to the upper nut 120 to prevent the upper nut 120 from being loosened.

The double nut having the anti-loosening part 200 according to the present invention is applicable to all structures or industrial fields (for example, train rails) wherein impacts and vibrations are continuously applied to fastened portions and is further applicable to fastening for service structures disposed on piers or bridges accompanying vibrations by allowing the lower nut 110 and the upper nut 120 to be lockedly fastened to both ends of the elastic coil spring 210 fitted to the outer peripheral surface of the bolt 20 in the opposite direction to the direction of the screw thread formed on the outer peripheral surface of the bolt 20.

So as to allow the double nut having the anti-loosening part 200 according to the present invention to be loosened, the upper nut 120 rotates in the direction of the screw thread of the bolt 20 in the state where it is spaced apart from the lower nut 110 to allow the cross section thereof to correspond to the cross section of the lower nut 110, and next, after the lower nut 110 and the upper nut 120 are at the same time accommodated in a groove of an impact driver, they rotate at the same time.

As the lower nut 110 and the upper nut 120 rotate at the same time, in this case, even the elastic coil spring 210, which is disposed between the lower nut 110 and the upper nut 120, rotates together with the lower nut 110 and the upper nut 120, without being changed in pressure, so that the double nut can be disassembled.

Contrarily, if the lower nut 110 and the upper nut 120 are not at the same time unfastened through the impact driver as shown in FIG. 7, it is difficult to change the rotational angles of the lower nut 110 and the upper nut 120 with respect to the bolt 20 by means of the elastic coil spring 210 having both ends locked onto the locking groove 111 of the lower nut 110 and the locking groove 121 of the upper nut 120, even in the state where impacts or vibrations are continuously applied to the lower nut 110 and the upper nut 120 from the outside.

Even if the upper nut 120 is temporarily rotatingly unfastened, it is just returned to its original position by means of the elasticity of the elastic coil spring 210.

As described above, the double nut having the anti-loosening part according to the present invention can physically restrain the loosening directions of the nuts, so that even if vibrations are continuously applied thereto, the fastened states of the nuts can be firmly kept to provide stability for structures fastened by the bolt and the nuts.

In addition, the double nut having the anti-loosening part according to the present invention can provide easy machinability so that it is applicable to a large-sized specific bolt and is thus adopted as a large-sized double nut for industry.

Further, the double nut having the anti-loosening part according to the present invention can enhance machinability upon manufacturing through a simple structure, thereby providing a low manufacturing cost and high product competitiveness.

The technical scope of the present invention has been defined through the disclosed embodiments.

It is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

The present invention is applicable to technical fields of construction, civil engineering, and machine assembling wherein objects are fixed.

What is claimed is:

1. A double nut comprising:
a double nut part having a lower nut fastened to a lower peripheral surface of a protruding region of a bolt inserted protrudingly into fastening holes formed on fastening objects to be fastened together and an upper nut fastened to an upper peripheral surface of the protruding region of the bolt; and
an anti-loosening part disposed between the lower nut and the upper nut to apply elasticity to the lower nut and the upper nut in a direction where the lower nut and the upper nut are distant from each other,
wherein the lower nut has a locking groove formed on top thereof and the upper nut has a locking groove formed on underside thereof, so that one end of the anti-loosening part is locked onto the locking groove of the lower nut, and the other end of the anti-loosening part is locked onto the locking groove of the upper nut upon the rotation of the upper nut in one side direction, while being not locked thereonto upon the rotation of the upper nut in the opposite direction to one side direction; an advancing direction of a guide groove reaching the locking groove of the lower nut is opposite to an advancing direction of a guide groove reaching the locking groove of the upper nut; and advancing directions of extended lines from the anti-loosening part correspond to the advancing direction of the guide groove of the lower nut and the advancing direction of the guide groove of the upper nut.

2. The double nut according to claim 1, wherein the guide groove of the lower nut is spirally formed concavely on the top thereof in a circumferential direction of the anti-loosening part and the locking groove of the lower nut is formed on a boundary region on which both ends of the guide groove come into contact with each other, top and bottom ends of the locking groove being connected to both ends of the guide groove; and the guide groove of the upper nut is spirally formed concavely on the top thereof in the circumferential direction of the anti-loosening part and the locking groove of the upper nut is formed on a boundary region on which both ends of the guide groove come into contact with each other, top and bottom ends of the locking groove being connected to both ends of the guide groove.

3. The double nut according to claim 2, wherein the anti-loosening part is an elastic coil spring having tip portions gradually narrow in width toward one end and the other end thereof.

4. The double nut according to claim 3, wherein a direction of a screw thread formed on the outer peripheral surface of the bolt is opposite to a spiral direction of a coil constituting the elastic coil spring.

5. The double nut according to claim 3, wherein the locking groove of the lower nut and the locking groove of the upper nut have symmetrical shapes to each other in such a manner as to become concave in an advancing direction of the elastic coil spring.
